(19) United States
(12) Patent Application Publication
(10) Pub. No.: US 2003/0185925 A1
(43) Pub. Date: Oct. 2, 2003

(54) Cool-dissolving apparatus and heat-dissolving apparatus for producing polymer solution and products thereof

(75) Inventors: Takuro Nishimura, Minami-Ashigara-Shi (JP); Yukihiro Katai, Minami-Ashigara-Shi (JP)

Correspondence Address: YOUNG & THOMPSON, 745 SOUTH 23RD STREET 2ND FLOOR, ARLINGTON, VA, 22202

(73) Assignee: FUJI PHOTO FILM CO., LTD., Minami-Ashigara-Shi (JP)

(21) Appl. No.: 10/400,530

(22) Filed: Mar. 28, 2003

(30) Foreign Application Priority Data
Mar. 29, 2002 (JP) 2002-095036

(51) Int. Cl. B29C 41/28; B29C 47/82

(52) U.S. Cl. 425/224; 425/378.1

(57) ABSTRACT

A cool-dissolving apparatus for producing a solution from a mixture of polymer and solvent includes a double-structure pipe which is constructed of a cylinder and a jacket surrounding the cylinder. A mixture is fed in the cylinder, and a cooling medium flows in a space between the cylinder and the jacket oppositely to the mixture in the cylinder such that polymer dissolves to the solvent. The obtained solution is supplied in a heat-dissolving apparatus including a pipe for feeding the solution. In the heat-dissolving apparatus, the pipe extends horizontally or upwards in a feeding direction of the solution.

### BACKGROUND OF THE INVENTION

1. Field of the Invention

The present invention relates to a cool-dissolving apparatus and a heat-dissolving apparatus for producing a polymer solution and products thereof.

2. Description Related to the Prior Art

Polymers are used in several fields. Polymer products, such as plastic film and the like, are produced from a liquid made by heating and melting polymers or a solution made by dissolving the polymers in a solvent. When it is designated to use the solution in a solvent casting method, the solvent is evaporated during producing the polymer products. In the solution, the polymers can be dissolved at a predetermined density. It is necessary to use a solvent having a boiling point adequate for security and evaporation. Particularly in these days, the security for human bodies and circumstances is required. Therefore, it becomes harder to find the adequate solvent for satisfying these conditions from several solvents which can dissolve the polymers.

For example, methylene chloride has been used as the solvent for the cellulose triacetate in prior arts. However, the use of the methylene chloride becomes restricted while there happens several problems about human bodies and circumstances of the earth. Acetone, a well known organic solvent, has the adequate boiling point (56° C.) and does not damage the human bodies and the circumstances of the earth. The cellulose triacetate cannot melt in acetone in any known methods, even though swelling in acetone.

Accordingly, a method for producing the polymer solution is proposed, in which a cooling apparatus and a heating apparatus is combined. The cooling apparatus is provided with a screw mixer, while the heating apparatus with a static mixer. For example, Makromol, Chem. Vol. 143, Page 105 in an essay of J. M. G. Cowie et al. (1971) reports a method how to obtain a dilute solution. In the method, cellulose acetate, whose degree of substitution is from 2.80 to 2.90 (degree of acetylation is from 60.1% to 61.3%), is cooled in acetone between −80° C. and −70° C., and thereafter heated such that the cellulose acetate may melt in acetone at a density between 0.5 wt. % and 5 wt. % to become the dilute solution. Hereinafter, such a method in which a mixture of the polymers and the solvents is cooled and thereafter heated for obtaining the polymer solution is called a cooling method for dissolving. The method for dissolving the cellulose acetate in acetone is described in the essay “Dry spinning from a cellulose triacetate solution in acetone” of Kenji Kamide, in Magazine of THE TEXTILE MACHINERY SOCIETY OF JAPAN, Vol. 34, Page 57-61 (1981). In the essay, as the title thereof teaches, the cooling method for dissolving is applied to a field of techniques according to spinning methods. Considering mechanical characters and dye properties of the obtained fibers and shapes in section of the fibers, the essay teaches that the cellulose triacetate solution can be obtained at a density between 10 wt. % and 25 wt. % in the cooling method for dissolving.

However, it is hard to feed a solution in a cooling apparatus when the solution is cooled at an extremely low temperature. Accordingly, the feeding velocity of the mixture of the polymer and the solvent at less than −50° C. become lower without controlling the cooling condition adequately, which causes the problems of producing the polymer solution. This tendency becomes larger extremely when the density of the polymers becomes higher in the mixture, and there is a limitation of the density, over which the mixture cannot be fed. Further, it becomes harder to feed the mixture in cylinders of the screw mixer that is cooled at −70° C., and no mixture can be often fed.

When it is designated to use both of the cooling apparatus and the heating apparatus for producing the polymer solution, then the cooling apparatus and the heating apparatus must be disposed at an adequate position. In the quick variation of viscosity by cooling (or heating) the polymer solution, a void is generated in the heating apparatus, which causes the generation of the polymer membrane and the solidification of the polymer. Accordingly, in processes of producing the polymer solution, the filtration device is provided to remove the polymer membrane and the gel-like materials thereof. However, as these are generated so much, the life of the filter becomes shorter, and the cleansing of the filter must be made more often, which causes to increase the cost.

Further, the temperature of the polymer solution cannot be adjusted to the predetermined one without controlling the temperature of the heating apparatus. For example, the mixture is heated at the temperature more than the boiling point of the solvent, the solvent evaporates so much, which causes the solidification of the produced solution. Furthermore, when the solution at high density that contained large amount of gas is cast on a substrate for producing a film, then the bubbles generates in the solution on the substrate. Accordingly, the produced film would have pin holes, unevenness, retractions, protrusions and the like on a surface thereof.

### SUMMARY OF THE INVENTION

An object of the present invention is to provide a cool-dissolving apparatus, in which a mixture of polymer and solvent is smoothly fed, and with which a polymer solution of high quality is effectively produced.

Another object of the present invention is to provide a heat-dissolving apparatus in which it is prevented to generate the thin membrane and gel-like material in the polymer solution, while it is heated.

Still another object of the present invention is to provide a cool-dissolving apparatus and a heat-dissolving apparatus for preparing a polymer solution for producing a film having excellent optical characteristics, such as a protective film for a polarizing filter which is used in a liquid crystal display.

In order to achieve the object and the other objects, a mixture feed section of a cool-dissolving apparatus of the present invention is provided with an opening through which a mixture of polymer and solvent is supplied. The cool-dissolving apparatus includes a cooling section for adjusting the temperature of the mixture in the mixture feed section. The cooling section is constructed of at least two temperature setting parts which are disposed along the mixture feed section. When the mixture is fed through the mixture feed section to an end portion thereof, the temperature of the mixture is adjusted in the fist temperature setting part at the opening and in the last temperature setting part at the end portion so as to be lower in the last temperature setting part than in the first temperature setting part. Thereby the mixture is cooled such that the polymer dissolves to the solvent.

In the present invention, the mixture feed section is a pipe of a double structure that is constructed of an inner wall and an outer wall which are disposed concentrically. In the inner wall, a screw is provided and rotated for feeding the mixture. Further, there is a space between the inner and outer walls. The space is partitioned at a border of the neighboring temperature setting parts so as to form plural chambers. The temperature control means is a cooling medium, and the cooling medium is supplied in each chamber, and cools the mixture in the pipe. Furthermore, a medium passage is formed in the screw, and a temperature control medium flows through the medium passage to control a temperature of the screw.

In a heat-dissolving apparatus of the present invention, a pipe in which the polymer solution is fed is provided so as to always extend horizontally or upwards in a feeding direction of said polymer solution. A controller controls a temperature of the polymer solution in the pipe so as to be higher at exiting from than at the entering in the heat-dissolving apparatus.

The polymer solution discharged from the heat-dissolving apparatus is mixed with additives and thereafter cast on a substrate in a film producing line. The temperature of the polymer solution is higher at casting than at exiting from the heat-dissolving apparatus.

According to the cool-dissolving apparatus of the present invention, the temperature of the mixture or the polymer solution is controlled so as to be higher in the first temperature setting part than in the last temperature setting part. Further, the temperature of the cooling medium for cooling the mixture is different in accordance with the temperature setting parts. Accordingly, the mixture can be smoothly supplied in the cool-dissolving apparatus, and the polymer solution to be obtained has high quality.

Further, the screw used in the cool-dissolving apparatus of the present invention is provided with a passage in which the temperature control medium for controlling the temperature of the screw flows. Accordingly, the mixture can be smoothly supplied in the cool-dissolving apparatus, and the polymer solution can be effectively produced.

According to the heat-dissolving apparatus of the present invention, the pipe is provided so as to always extend horizontally or upwardly in the downward side, and the heat controller controls the temperature of the polymer solution so as to be higher at exiting from than at entering in the heat-dissolving apparatus. Accordingly, it is prevented to generate the voids and the solid material in the polymer solution that is caused by the voids, such the polymer membrane and the like.

Further, in the heat-dissolving apparatus of the present invention, the temperature of the polymer solution is lower at exiting than at being cast on the substrate in the film producing line. Accordingly, it is prevented to generate the air bubbles from air dissolved in the polymer solution, and the film produced from the polymer solution has a high quality. Furthermore, the film is used as an optical film such as a protective film for a polarizing filter, and used in the liquid crystal display.

### BRIEF DISCRIPTION OF THE DRAWINGS

The above objects and advantages of the present invention will become easily understood by one of ordinary skill in the art when the following detailed description would be read in connection with the accompanying drawings.

FIG. 1 is a sectional view of a cool-dissolving apparatus of the present invention;

FIG. 2 is an extended partial view of the cool-dissolving apparatus of FIG. 1;

FIG. 3 is a diagrammatical sectional view of a first embodiment of a heat-dissolving apparatus of the present invention;

FIG. 4 is a diagrammatical sectional view of a second embodiment of a heat-dissolving apparatus of the present invention;

FIG. 5 is a diagrammatical sectional view of a third embodiment of a heat-dissolving apparatus of the present invention;

FIG. 6 is a schematic diagram of a film producing line in which a film is produced from a polymer solution supplied from the heat-dissolving apparatus of the present invention;

FIG. 7 is a schematic diagram of a part of the heat-dissolving apparatus of the invention.

### PREFERRED EMBODIMENTS OF THE INVENTION

In the present invention, a combination of polymers and solvents is selected such that the polymer may swell in the solvent at a temperature between 0° C. and 55° C., at which a produced polymer solution is to be used. If the polymers do not swell in the solvent, the polymers hardly dissolve in the solvent even with cool-dissolving method. When the polymer dissolves in the solvent at the above temperature, the solution may be produced uniformly in the cool-dissolving method of the present invention faster than in method of agitating the solution at normal or high temperature in the prior art. As the polymers, there are polyamides, poly olefins (norbornene, for example), polystyrenes, polycarbonates, polysulfones, polyacrylic acids, polymethacrylic acids, polyetheretherketones, polyvinylalcohols, polyvinylacetates, and cellulose derivatives (for example, low fatty acid esters, cellulose acylate and the like). Especially preferable are cellulose acylates.

In the cellulose acylates, especially preferable are low fatty acid esters of cellulose acylates, about which an explanation will be made. Low fatty acid is a fatty acid containing uppermost 6 carbons. The number of the carbons is preferably 2 (cellulose acetate), 3 (cellulose propionate) and 4 (cellulose butylate). Preferable is cellulose acetate, and especially preferable is cellulose triacetate (degree of acetylation: 58.0%-62.5%). However, in the present invention other polymer may be used).

As the solvent, inorganic solvent is preferable to organic solvent. As the organic solvents, there are ketones (for example, acetone, methylethylketone, cyclohexanone and the like), esters (for example, methyl formate, methyl acetate, ethyl acetate, amyl acetate, butyl acetate and the like), eters (for example, dioxane, dioxolane, tetrahydrofuran, diethyl ether, methyl-t-butyl ether and the like), aromatic hydrocarbons (for example, benzene, toluene, xylene, hexane, and the like), hydro carbon of fatty group (for example, hexane, heptane and the like), and alcohols (for example, methanol, ethanol and the like). Further, hydrogen of the hydrocarbon of fatty group may be substituted to chlorine; for example, methylene chloride, chloroform, and the like. The solvent is a liquid in which the polymer can swell, as above described. Accordingly, kinds of the solvent are determined in accordance with kinds of the polymers. For example, when the polymers are cellulose triacetate, polycarbonates and polystyrenes, then it is preferable to use acetone and methyl acetate as the solvent. Further, when the polymers are norbornene type polymers, then it is preferable to use benzene, toluene, xylene, hexane, acetone and methylethylketone as the solvent. When the polymers are polymethylmetacrylate, then it is preferable to use acetone, methylethylketone, methyl acetate, butyl acetate and methanol as the solvent. More than two of them may be mixed to use as the solvent.

Methyl acetate type solvent containing more than 50 wt. % of methyl acetate is preferably used. The ratio of the methyl acetate in the solvent is preferably more than 60 wt. %, particularly more than 70 wt. %. Further, only the acetylic acid may be used as the solvent (thereby the ratio thereof is 100 wt. %). Furthermore, a mixture of other solvents and the methyl acetate may be used for adjusting a property (for example viscosity) of the solution to be produced. In the organic solvents already mentioned, hydrocarbons and alcohols are especially preferable, which can be used with methyl acetate. More than two solvents may be used with the methyl acetate. Note that the solvents used in the present invention are not restricted in accordance with the boiling point. However, they have the boiling point preferably between 40° C. and 100° C. especially preferably between 50° C. and 80° C.

[Medium for Adjustment of Temperature]

A medium for adjustment of temperature (hereinafter medium, or cooling medium) that is used in the cool-dissolving apparatus of the present invention preferably has a melting point below 0° C. and a boiling point above 30° C. Preferably, the cooling medium has the viscosity less than 2×10⁻⁴ m²/s at the temperature when in used. The representative examples of the cooling medium are Fluorinert (Trademark), brine, methanol and the like, especially Fluorinert. However, the cool-dissolving method used in the present invention is not restricted in them.

[Swelling Process]

In the swelling process, the polymers are mixed with the solvent so as to swell therein. The temperature of the swelling process is preferably set between −10° C. and 55° C., and usually at a room temperature. The ratio of the polymers to the solvent is determined in accordance with the density of the solution to be obtained. When it is designated to compensate the cooling medium in the cooling process, then the amount of the cooling medium reduced for the compensation. Usually, the preferable density of the polymers is from 5 wt. % to 30 wt. % of the solution, particularly from 8 wt. % to 20 wt. %, especially from 5 wt. % to 15 wt. %. Preferably, the mixture of the polymers and the solvents is agitated such that the polymers may swell enough for 10-15 minutes, particularly 20-120 minutes. Thus the mixture becomes a swelling agent. In the swelling process, other components may be also added, for example, plasticizers, anti-deterioration agent, ultraviolet stabilizers than the polymer and the solvents.

[Cooling Process]

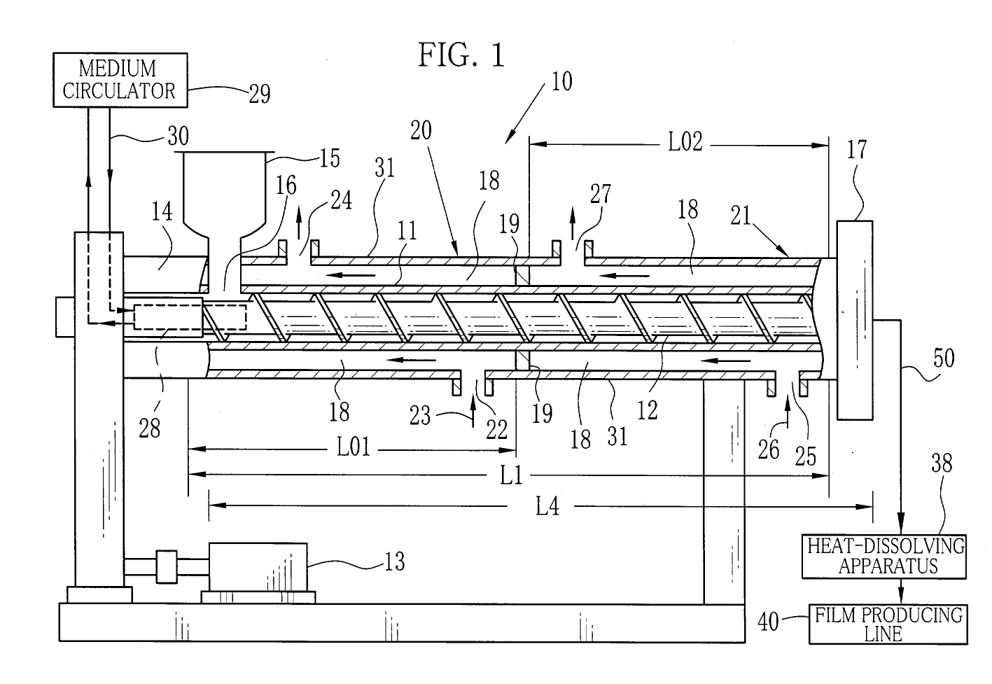

In FIG. 1, a cool-dissolving apparatus 10 has a cylinder 11 in which a screw bar 12 is provided. The screw bar 12 is rotated with applying of a rotational force by a motor 13. When the motor 13 drives, the rotational force is transmitted through a reduction mechanism 14 to the screw bar 12. Thus the rotational speed becomes lower in the screw bar 12 than in a rotary shaft of the motor 13. A hopper 15 is supplied with the swelling agent (not shown), which is fed through a supply opening 16 into the cylinder 11. Note that a solvent may be supplied in order to adjust the density of the swelling agent in the hopper 15. The swelling agent is a mixture containing polymer and solvent.

The swelling agent fed through the supply opening 16 into the cylinder 11 is agitated by the rotating screw bar 12, and the polymers dissolves to the solvent to obtain the polymer solution (hereinafter dope) 50. The dope 50 is discharged from an outlet opening (not shown) formed in a cylinder end 17 of the cylinder 11, and thereafter fed to a heat-dissolving apparatus 38 and a film producing line 40 sequentially.

Determining P1 as a pressure for feeding the swelling agent into the cylinder, and P2 as that for feeding the dope 50 from the outlet opening, it is preferable to adjust the number of rotation of the screw bar 12 for obtaining the dope 50 in an adequate situation such that the difference |P2−P1| is less than 10 Mpa. Accordingly, it is preferable to control the number of rotation of the screw bar 12 is between 1 rpm and 200 rpm.

In the cool-dissolving apparatus 10 of the present invention, a medium jacket 31 is provided around the cylinder 11 to construct a pipe having a double passage structure and to form a space 18 between the cylinder 11 and the medium jacket 31. In the space 18, a cooling medium 23 is fed for cooling the cylinder 11 and the screw bar 12, the swelling agent and the dope 50. Further, as shown in FIG. 1, the space 18 is separated with a separation plate 19 into chambers of a first temperature setting part 20 and a second temperature setting part 21. The cooling medium 23 enters through a medium entrance 22 in the first temperature setting part 20, and discharged from a medium exit 24. Thereby the swelling agent fed in the cylinder 11 by the pressure of the screw bar 12 is cooled. Further, a cooling medium 26 enters through a medium entrance 25 in the second temperature setting part 21, and discharged from a medium exit 27, to cool the swelling agent and the dope 50.

In the present invention, the temperature of the cooling medium 23 fed in the first temperature setting part 20 is set to be higher than that of the cooling medium 26 fed in the second temperature setting part 21. Thus the swelling agent in the hopper 15 is easily fed through the supply opening 16 into the cylinder 11, and the dissolution of polymer is expedited. Preferably, the temperature of the cooling medium 23 is set between −60° C. and 0° C., and that of the cooling medium 26 is set between −100° C. and −45° C. Further, it is preferable that the difference of the temperature between the two cooling mediums 23 and 26 is between 1° C. and 100° C. for effectively feeding the swelling agent, and the dissolution of polymer is expedited.

The difference of the temperature of each cooling medium 23, 26 between the medium entrance 22, 25 and the medium exit 24, 27 is preferably less than 50° C. In this case, the cooling medium 23, 26 hardly evaporate, and it is prevented to damage the cylinder 11 and the medium jacket 31. Further, when the feeding velocity of the cooling medium 23, 26 in the space 18 is set between 0.01 m/s and 10 m/s, then the cylinder 11 and the like are effectively cooled. Further, it is preferable for effectively cooling the swelling agent that the cooling mediums 23, 26 in the space 18 are fed oppositely to the swelling agent in the cylinder 11. Further, the total coefficient of heat transfer from the swelling agent to the cooling mediums 23, 26 is set between 1 W/(m²·K) and 1000 W/(m²·K), preferably for effectively cooling the swelling agent. When the total coefficient of heat transfer is less than 1 W/(m²·K), then the cooling medium 23, 26 cannot enough cool the swelling agent, and the polymer often cannot dissolve smoothly. Further, when the total coefficient of heat transfer is more than 1000 W/(m²·K), then the dope 50 often cannot be uniformly.

In the space 18 having a length Li in the above embodiment, the first temperature setting part 20 has a length L0, and the second temperature setting part 21 has a length L02. However, it is not restricted that the space 18 is separated into two chambers. When the temperature of the cooling medium is higher at the temperature setting part of feeding the swelling agent into the cool-dissolving apparatus than at the temperature setting part of discharging the dope 50, then the swelling agent is smoothly supplied and the dope 50 can be easily obtained. In order to gradually cool the swelling agent, it is preferable that when the space 18 having the length L1 is separated into N temperature setting parts, then a N^{th} temperature setting part has a length L0N which is set in the following region: (0.1×L1/N)<L0N<(2×L1/N).

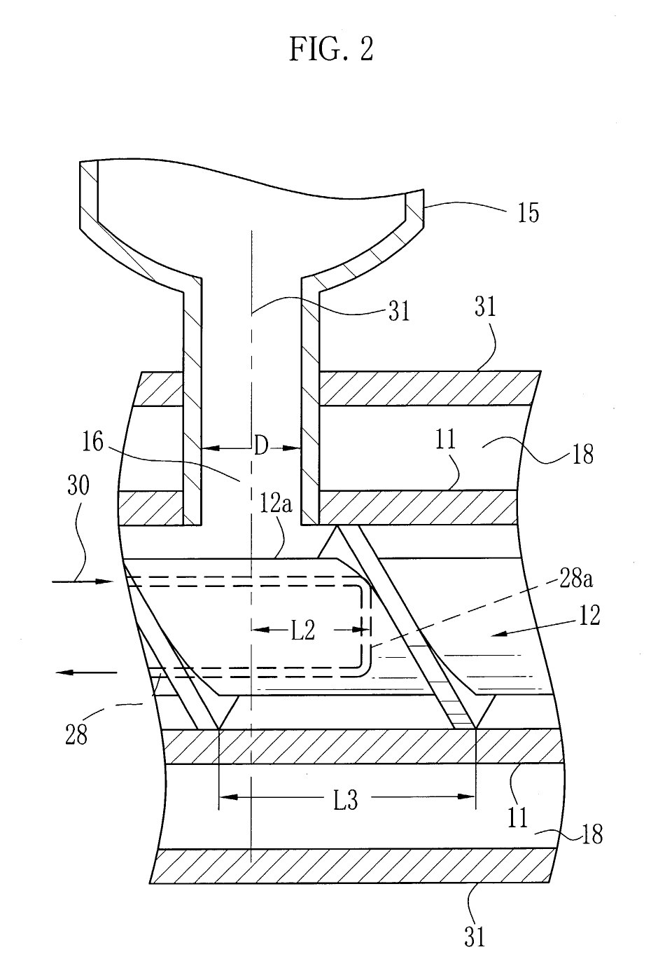

The screw bar 12 is connected with a medium circulator 29, and the medium circulator 29 feeds a temperature control temperature control medium 30 through a pipe (not shown) into a medium passage 28. As shown in FIG. 2, the medium passage 28 is formed in the screw bar 12 in a side of the supply opening 16, and the temperature control medium 30 flows in the medium passage 28 so as to regulate the temperature of the screw bar 12 at the supply opening 16. In order to keep the predetermined temperature of the screw bar 12, a flow rate of the temperature control medium 30 flowing in the medium passage 28 is preferably between 0.1 L/min and 100 L/min. However, the flow rate of the temperature control medium 30 is not restricted in the embodiment, as it depends on the predetermined temperature.

It is to be noted that the temperature control medium 30 is not restricted in the medium for adjustment of temperature that is mentioned above. Further, in FIG. 1, the temperature control medium 30 is circulated with the medium circulator 29. However, the present invention is not restricted in the above embodiment.

When an end portion 28a of the medium passage 28 is positioned closer to the outlet opening of the cylinder end 17 of the cylinder 11, the regulation of the temperature in the first temperature setting part is often not carried out effectively. Further, when the end portion 28a does not have an enough length below the supply opening 16, it becomes hard to regulate the temperature of the swelling agent in a first temperature setting part 20. Accordingly, as shown in FIG. 2, a pitch of a screw in the screw bar 12 is L3, and the diameter of the supply opening 16 is D, and the medium passage 28 protrudes into a feeding direction of the swelling agent in the cylinder 11 at a length L2 from a central line CL of the supply opening 16. Then it is preferable that the length L2 satisfies; (D/2)≦L2≦(L3/2). Further, when the cross section of the supply opening is not circle, the medium passage 28 is formed in accordance with an imaginary line which extends through the center of gravity of the supply opening 16. Furthermore it is preferable by feeding the swelling agent through the supply opening 16 that the viscosity of the swelling agent is less than 10⁴ Pa·s, and that the elastic modulus is more than 10⁶ Pa.

Supposed that the swelling agent has the temperature T1 during passing through the supply opening 16, and that a part 12a of the screw bar 12 at the supply opening 16 has the temperature T2, it is preferable that the difference (T2−T1) is between −100° C. and 0° C. When the difference of the temperature is less than −100° C., then the temperature of the screw bar 12 is so low that the swelling agent becomes solidified and cannot be fed in the cylinder 11. Further, when the difference of the temperature is more than 0° C., the temperature of the swelling agent is so low that the swelling agent becomes solidified, and cannot fed out from the hopper 15.

The cool-dissolving apparatus for dissolving of this embodiment the screw type mixer is used as illustrated in FIGS. 1 and 2. However, the present invention is not restricted in it. For example, a double pipe type static mixer may be used in the cool-dissolving apparatus for dissolving. In this case, the cooling medium is fed through outer pipes into the static mixer the same as the screw bar of the jacket type in the above embodiment. Further, in the above embodiment, the cooling medium is fed in the passage to cool the cylinder. However, a vapor compressing refrigerating machine and the like may be used for cooling the cylinder. Further, in the above cool-dissolving apparatus for dissolving, the swelling agent that the polymers have been swollen in the solvent is used. However, in the present invention, the swelling process may be omitted, and the mixture of the polymer, the solvent and additives may be supplied in the hopper 15 and fed into the cylinder 11 to dissolve during cooling for obtaining the dope 50.

In FIG. 1, the swelling agent has the temperature T01 when it is fed through the supply opening 16 to the screw bar 12, and the temperature T02 when it is fed out through the outlet opening of the cylinder end 17. When the temperature T01 is higher than the temperature T02 in the cool-dissolving apparatus for dissolving, then the present invention is not restricted in the above embodiment.

The preferred temperature of the swelling agent in the cylinder 11 will be explained as follows. The length L4 is that between a first position and a second position. The first position is the upstream edge of the supply opening 16, and the second position is the downstream end of the outlet opening in the cylinder end 17. A third position is determined as a voluntary position of the swelling agent in the cylinder 11. A relative value Rv is determined as a ratio of the length between the first position and the third position to the length L4. Accordingly, the relative value Rv is 0 at the supply opening 16 and 1 at the outlet opening of the cylinder end 17. In this case, the temperature of the swelling agent is regulated in the following condition:

T(° C.)≧−400×Rv−20(0≦Rv≦0.1)

T(° C.)≧(−1/9)×(200×Rv+520)(0.1<Rv≦1.0)

When the conditions are satisfied, then the swelling agent hardly becomes solidified, and can be fed in the cylinder smoothly for preparing the dope 50. Especially when the temperature T is too low at the first position at the supply opening 16, the swelling agent is overcooled and becomes solidified, which prevents the smooth feeding. Otherwise, when the temperature becomes too high in the condition 0≦Rv≦0.1, then the swelling agent is often cannot have the predetermined temperature. Accordingly, it is preferable that the temperature T of the swelling agent is not too high. Further, when the temperature is too high in the condition 0.1<Rv≦1.0, then the effects of dissolving with cooling down is not enough.

[Heating Process]

The feeding of the dope 50 from the cool-dissolving apparatus 10 to the heat-dissolving apparatus 38 may be carried out with feeding lines or with receive vessels, in which the dope 50 is stored, and which is thereafter conveyed to the heat-dissolving apparatus. In the heat-dissolving apparatus 38, the dope 50 is heated to have the temperature between 0° C. and 120° C., preferably between 0° C. and 55° C. The temperature at the last of the heating process is usually the room temperature. Preferably, the heating speed is more than 1° C./min, particularly more than 2° C./min, especially more than 4° C./min, and most especially 8° C./min. It is preferable that the heating speed becomes larger. The limit is theoretically 10000° C./sec., technically 1000° C./sec., and practically 100° C./sec. Note that the heating speed is determined as an average calculated by dividing the difference of the temperature between start and end of heating by seconds for heating. Further, when the polymer does not dissolve in the heat-dissolving apparatus enough, the dope 50 is supplied to the cool-dissolving apparatus 10 of the present invention again. Thus the cooing process and the heating process may be made again. It is judged in observation with eyes whether that the dissolving is made enough. As described above, the polymer solution can be obtained with a combination of the cool-dissolving apparatus and the heat-dissolving apparatus in the present invention. Note that the heat-dissolving apparatus may be provided with a heat exchanger including a static mixer, a heat exchanger of autoclave type and multi-pipe type, or a screw feeding machine.

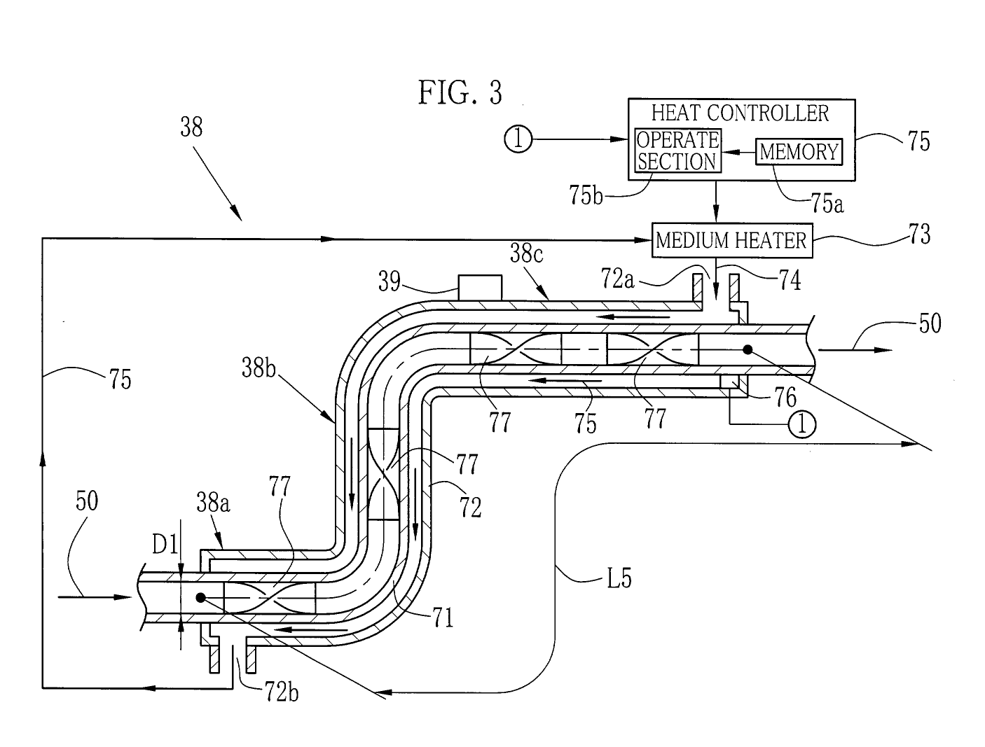

As shown in FIG. 3, the heat-dissolving apparatus 38 includes a pipe 71 in which the dope 50 is fed, a jacket 72 covering the pipe 71 to make it hot, and static mixers 77. The heat-dissolving apparatus 38 is constructed of an upstream section 38a, a middle section 38b and a downstream section 38c. The upstream and downstream sections 38a, 38c are set horizontally. The upstream section 38a is positioned lower than the downstream section 38c. The middle section 38b is positioned perpendicularly to connect the up- and downstream sections 38a, 38c. In the present invention, the diameter Dl of the pipe 71 is preferably from 27.6 mm to 105.3 mm. However, the diameter is not restricted in it. Further, the length L5 of the pipe 71 is preferably from 0.5 m to 10 m. However, the length L5 is not restricted in it.

The jacket 72 is provided with an opening 72a in the downstream section 38c and an opening 72b in the upstream section 38a in order to feed a heating medium 74. After heated in the medium heater 73, the heating medium 74 is supplied through the opening 72a into a space between the jacket 72 and the pipe 71. Further, the medium heater 73 is connected to a heat controller 75 for regulating the temperature T05 of the heating medium 74, so as to adjust in the downstream section 38c the temperature of the dope 50 fed in the pipe 71. The downstream section 38c has a thermo sensor 76 close to an exit of the heat-dissolving apparatus 38 for measuring the feed-out temperature T03 of the dope which exits from the heat-dissolving apparatus 38. Preferably, the heating medium 74 is fed oppositely to a feeding direction of the dope 50 to make the heating effectively. However, the present invention is not restricted in it, and the heating medium 74 may be fed in the feeding direction of the dope 50. After discharged through the opening 72b, the heating medium 74 is fed back to the medium heater 73, and heated to have the temperature T05. It is preferable that the heating medium 74 has a large specific heat and the decomposition, chemical denaturation or the like hardly occurs even in variation of the temperature. Concretely, water, hot water, steam, oil and the like may be used, and hot water is especially preferable. However, the present invention is not restricted in them. Further, the temperature T05 of the heating medium 74 is preferably between 1° C. and 99° C. However, the present invention is not restricted in them. Furthermore the heat controller 75 is used in the above embodiment. However, the present invention is not restricted in it.

The static mixers 77 are provided in the pipe 71. Preferably, the number of the static mixer 77 is more than 20 and less than 100. However, the number is not restricted in it. Note that the number of the static mixer 77 is only four in the figure for simplicity thereof. The dope 50 is fed in the pipe 71 to enter in the upstream section 38a. When supplied in the upstream section 38a, then the dope 50 has the temperature T06. Preferably, the temperature T06 is between −30° C. and −25° C. Thereby it is preferable that the viscosity of the dope 50 is between 10 Pa·s and 100000 Pa·s. However, the viscosity is not restricted in the region.

The dope 50 is heated through the heating medium 74 to have the predetermined temperature T03′. It is preferable that the predetermined temperature T03′ is less than the casting temperature T04 at casting the dope 50. Concretely, it is preferable that the predetermined temperature T03′ is between 30° C. and 40° C. However, the present invention is not restricted in it.

In the heat-dissolving apparatus 38, the total coefficient of heat transfer U for transferring the heat from the heating medium 74 to the dope 50 is preferably between 10 W/(m²·K) and 1000 W/(m²·K). However, the total coefficient U is not restricted in it. The linear velocity F of the dope 50 is calculated from the feeding velocity of a screw type mixer (not shown), and preferably between 0.06 m/min and 0.6 m/min. However, the linear velocity F is not restricted in it. The feed-out temperature T03 of the dope 50 exiting from the heat-dissolving apparatus 38 is measured by the thermo sensor 76. The total coefficient U and the linear velocity F of the dope 50 are stored in a memory 75a of the heat controller 75, in which the predetermined temperature T03′ is previously recorded.

When the heat-dissolving apparatus 38 is actuated, the thermo sensor 76 measures the feed-out temperature T03 of the dope 50 exiting from the heat-dissolving apparatus 38. Then a signal of the feed-out temperature T03 is sent to an operate section 75b of the heat controller 75. The operate section 75b calculates from the signals of the feed-out temperature T03 and each values (of the total coefficient U, the linear velocity F, the predetermined temperature T03′) to obtain an instruction signal for varying the temperature of the heating medium 74. The instruction signal is sent to the medium heater 73. Then the medium heater 73 feeds the heating medium 74 to the heat-dissolving apparatus 38 so as to identify the feed-out temperature T03 of the dope 50 with the predetermined temperature T03′. Thus the heating conditions of the dope 50 can be adjusted. It is to be noted that a thermo sensor may be provided on an outer surface of the pipe 71. In this case, the temperature of the dope 50 in the pipe 71 is estimated from the temperature measured with the thermo sensor on the outer surface of the pipe 71.

Further, the heat-dissolving apparatus 38 is provided with a pressure sensor 39. Preferably, a measured value of the pressure sensor 39 is more than the pressure of saturated aqueous vapor, and varied in a variable region. In order to make the regulation of pressure, a device (not shown) for regulating the linear velocity of the dope 50 or for regulating the pressure in the heat-dissolving apparatus 38 may be attached to the heat-dissolving apparatus 38. Further, there is a pressure regulation method in which the temperature of the heating medium is controlled. Otherwise, a plurality of these methods for regulating the situation of the dope 50 may be combined. When the pressure in the heat-dissolving apparatus 38 is regulated in the above methods, the generation of bubbles in the dope 50, which often causes a lack of uniformity of the dope 50, is prevented. Note that the shape and the form of the pressure sensor 39 is not restricted in those of the figure. Furthermore, when the pressure sensor 39 is used, it is preferable that a thermometer (not shown) is provided at the entrance of the heat-dissolving apparatus 38 for measuring the temperature of the dope 50.

The dope 50 is supplied at a lowest position of the heat-dissolving apparatus 38, and flows in the pipe 71 horizontally or oppositely to gravity. The static mixer 77 dissolves solid materials (for example gel-like material) remaining in the dope 50. Thus the uniform dope 50 is fed out at a highest position from the heat-dissolving apparatus 38. The dope 50 is fed upwards in the perpendicular direction opposite to gravity in the heat-dissolving apparatus 38. Accordingly, although the rising of the temperature of the dope 50 causes the variation of the viscosity, the generation of voids is prevented. However, the voids are sometimes generated in the dope 50. Also in this case, as a pressure is applied to feed the dope 50 through the pipe 71 in the heat-dissolving apparatus 38, the voids disappears soon. Thus the solidification of the dope, for example the generation of the polymer membrane, which is caused by the voids, is prevented.

The dope 50 has a viscosity between 10 Pa·s and 100000 Pa·s, when it is supplied in the heat-dissolving apparatus 38. While it flows in the pipe 71 having 0.5 m-10 m in the heat-dissolving apparatus 38, the dope 50 is heated such that the viscosity becomes lower by more than 10 Pa·s. Accordingly, the dope 50 can be fed out from the heat-dissolving apparatus 38 smoothly.

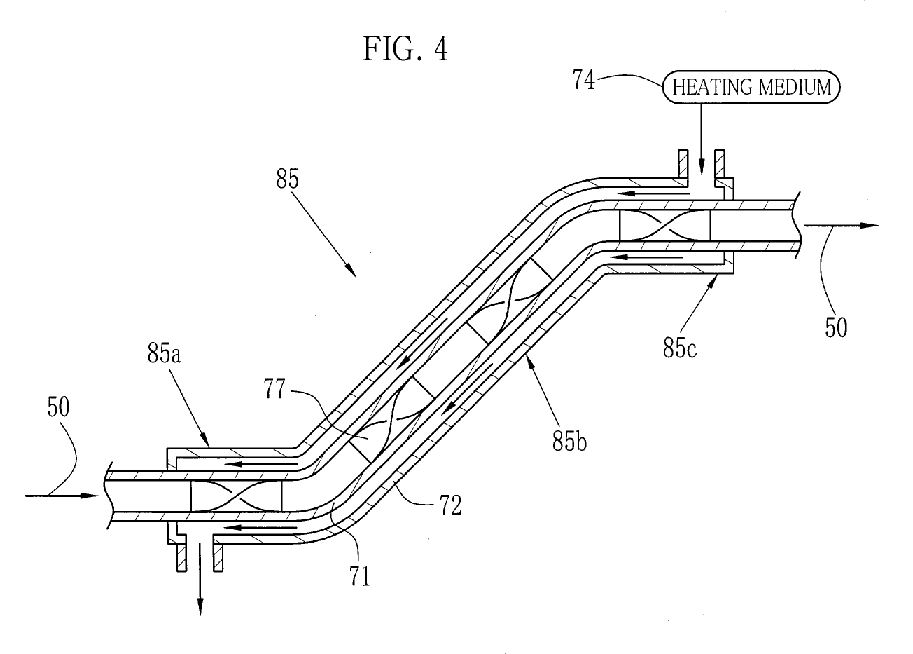

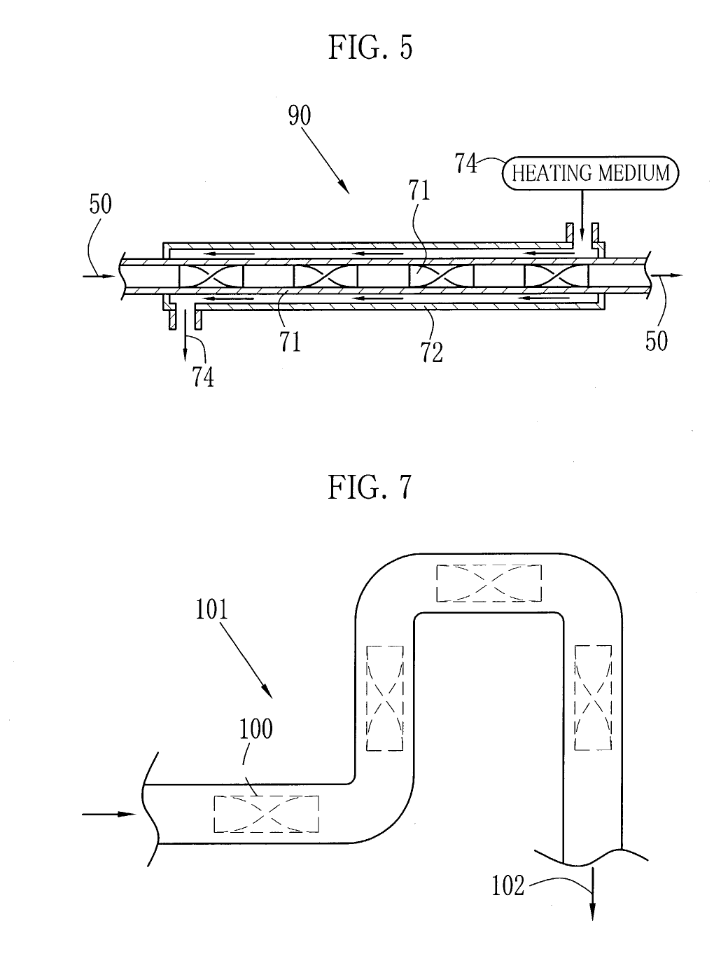

In this embodiment, the heat-dissolving apparatus 38 is constructed of the upstream section 38a, the middle section 38b and the downstream section 38c. However, the construction and the formation of the heat-dissolving apparatus of the present invention are not restricted in those of FIG. 3. Other embodiments of a heat-dissolving apparatus are illustrated in FIGS. 4 and 5. In these figures, the same components and elements as in FIG. 3 has the same indications, and the explanations therefor are omitted.

In FIG. 4, a heat-dissolving apparatus 85 is constructed of an upstream section 85a, a middle section 85b and a downstream section 85c. The upstream and downstream sections 85a, 85c are horizontal. The upstream section 85a is positioned lower than the downstream section 85c. The middle section 85b is provided with inclination to connect the up- and downstream sections 85a, 85c. In the middle section 85b, the dope 50 is fed upwards oppositely to gravity. In the up- and downstream sections 85a, 85c, the pressure is applied to feed the dope 50 in the horizontal direction. Accordingly, the heating mixer 85 has the same effects, especially for preventing the generation of the void, as the heat-dissolving apparatus 38 in FIG. 3.

In the present invention, a heat-dissolving apparatus 90 illustrated in FIG. 5 may be also used. In the heat-dissolving apparatus 90, the pipe 71 is set horizontally and the dope 50 is always fed in the horizontal direction. In this structure, as a pressure is applied to the dope 50 fed in the pipe 71, the generation of the voids is prevented. The heat-dissolving apparatus of the present invention is not restricted in FIGS. 3-5, as far as it is not provided with a descending section in which the dope 50 is fed downwards. If the descending section is provided, the position of the pipe is lower in the downstream of the pipe, and accordingly the voids generated in accordance with variation of the viscosity of the dope gathers at the top of the pipe to form an air bubble. The air bubble stays there and cannot be pushed out. The air bubble causes the generation of the thin membrane on a surface of the dope and the solidification of the dope. Note that the number of the static mixers is also not restricted in FIGS. 4 and 5, and usually larger than four.

It is to be noted that the processes with use of the heat-dissolving and cool-dissolving apparatuses may be carried out in a batch method, or in a continuous method in which the cool-dissolving apparatus and the heat-dissolving apparatus are connected.

[Processing After Producing Dope]

After producing the dope, there are several process, adjustment of density, filtration, regulation of temperature, adding of additives and the like, and necessary ones of them are made. Sorts of additives are selected in accordance with use of the dope. The representative additives are plasticizers, deterioration inhibitors (peroxide decomposer, radical inhibitor, metal deactivator, acid capture), dynes, and ultra-violet stabilizer. It is necessary to keep the dope in a predetermined region of temperature to be stable. For example, when the dope is prepared in a cool-dissolving method by dissolving the cellulose triacetate in the solvent of acetone, then there are a higher temperature region and a lower temperature region for phase separation. In order to keep the dope stably, the temperature of the dope is regulated in a middle temperature region in which the uniformity of the dope is kept. After these processing, the dope is used in several ways, for example in the film producing line.

[Producing of Film From Solution]

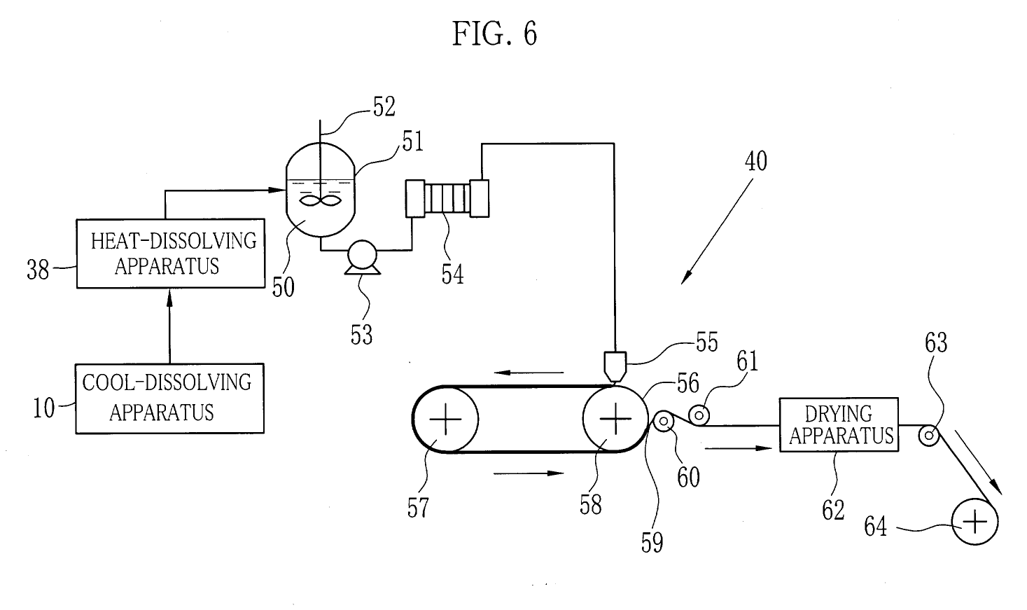

As shown in FIG. 6, the dope 50 prepared with the cool-dissolving apparatus and the heat-dissolving apparatus is supplied for a tank 51 of the film producing line 40. In the film producing line 40, it is preferable that the polymer of the dope 50 is cellulose acylate. However, sort of the polymer is not restricted in it. In the tank 51, the dope 50 is agitated with a mixer 52 so as to be uniform. Thereby, some additives may be added in the dope 50. It is preferable that the density of the dope is regulated, in which the density of solid matter is between 18 wt. % and 35 wt. %. The dope 50 is fed to a filtration device 54 at a predetermined feeding velocity by a pump 50 to remove foreign materials, and thereafter supplied for a die 55.

The die 55 casts the dope 50 on a belt 56. Thereby, it is preferable that the casting temperature T04 of the dope is higher than the feed-out temperature T03. In the organic solvent, when the temperature becomes higher, then the quantity of saturated dissolved air tends to be larger. Accordingly, in case that the casting temperature T04 is higher than the feed-out temperature T03, the generation of the air bubble is prevented as the amount of air contained in the dope is less than the saturation amount. Further, in the present invention, it is preferable that the feed-out temperature T03 is between 20° C. and 40° C., and that the casting temperature T04 is between 25° C. and 55° C.

The belt 56 is supported by rollers 57, 58, and rotated with a driving device (now shown). On the belt 56, the solvent of the dope 50 evaporates gradually to become a film 59. Preferably, a surface of the belt 56 is burnished to a mirror-like glass, and the temperature of the surface of less than 10° C. The film 59 is peeled from the belt 56 with a peeling roller 60, and fed into a drying apparatus 62. The temperature of the drying apparatus 62 is regulated preferably between 100° C. and 160° C. However it is not restricted in it. Further, the drying apparatus 62 is separated into several sections, and the temperature in each section is adjusted in accordance with the amount of remaining solvent in the film 59. After fed out from the drying apparatus 62, the film 59 is wound by a winding apparatus 64. Note that a method for producing film is not restricted in this embodiment. For example, it may be a method of multi-layer co-casting or sequential multi-layer casting for producing the film. Further, a drum may be used instead of the belt 56.

The produced film can be used for an optical thin film, such as a protective film in a polarizing filter. The protective film is adhered to a polarized film made of polyvinyl alcohol to obtain the polarizing filter. Further, there are other optical thin film, such as an optical compensation film and antireflection film. In order to obtain an optical compensation film, an optical anisotoropic layer may be provided on a surface of the produced film, and in order to obtain the antireflection film, a glare-reduction layer may be provided on the surface of the produced film. Further, the produced film is used in a liquid crystal display.

[Experiment]

The Experiment of the present invention was performed with the following examples and the comparisons. However, the present invention is not restricted in them. The detailed explanations were made in Examples 1 and 3. In other Examples and Comparisons, the same explanations were omitted.

### EXAMPLE 1

A method for preparing the dope from the mixture of large density cellulose triacetate and solvent is explained as follows. In this method, the screw type mixer (φ100) was used as the cool-dissolving apparatus in FIG. 1, in which the space between the cylinder and the passage pipe was separated into two parts. The mixture of large density cellulose triacetate and solvent was supplied in the screw type mixer. In the first temperature setting part, the cooling medium at −55° C. (the temperature thereof was −53° C. at the medium entrance and −49° C. at the medium exit) was fed into the space, and flew therein at 1 m/s of the feeding velocity oppositely to the mixture fed in the cylinder. In the second temperature setting part, the cooling medium at −80° C. (the temperature thereof was −80° C. at the medium entrance and −78° C. at the medium exit) was fed into the space, and flew therein at lm/s of the feeding velocity oppositely to the mixture fed in the cylinder. (The cooling medium was Novec FC-77, boiling point was 97° C., fluid point was −110° C., kinematic viscosity was 6.9×10⁻⁶ m²/s). The mixture at 30° C. was supplied in the cylinder with the screw rotating for three minutes. The rotation velocity of the screw was 30 rpm. The pressure applied to the dope which was discharged from the cylinder was smaller by 1 MPa than to the mixture which was supplied in the cylinder. Further, the cooled dope was heated with the heat-dissolving apparatus (here static mixer) to raise the temperature to 55° C., and thereafter filtrated with a metal filter whose absolute filtration accuracy was 0.01 mm. At first, as the discharging pressure did not become large, the flow rate of the dope fed in the cylinder was 300 L/min. However, it became 1 L/min after twenty minutes, and the dope was obtained in an adequate condition. The total coefficient of heat transfer was about 150 W/(m²·K). The dope was supplied for the film producing line 40 in FIG. 6, and the film was produced.

The mixture used in Example 1 contained the following materials:

| | |
|---|---|
| cellulose triacetate | 28 pts. wt. |
| (substitution degree, 2.83; viscosity average degree of | |
| polymerization, 320; degree of contained water, 0.4 wt. %; | |
| viscosity in 6 wt. % of methylene chloride solution, | |
| 305 mPa · s). | |
| methyl acetate | 75 pts. wt. |
| cyclopentanone | 10 pts. wt. |
| acetone | 5 pts. wt. |
| methanol | 5 pts. wt. |
| ethanol | 5 pts. wt. |
| plasticizer A (dipentaerythlitolhexaacetate) | 1 pts. wt. |
| plasticizer B (triphenylphosphate) | 1 pts. wt. |
| particles (SiO₂ having particle diameter 20 nm) | 0.1 pts. wt. |
| UV stabilizer a: 2,4-bis-(n-octylthio)-6-(4-hydroxy- | 0.1 pts. wt. |
| 3,5-di-tert-buthylanilino)-1,3,5-triazine) | |
| UV stabilizer b: 2(2′-hydroxy-3′,5′-di-tert- | 0.1 pts. wt. |
| butylphenyl)-5-chlorobenzotriazol | |
| UV stabilizer c: 2(2′-hydroxy-3′,5′-di-tert- | 0.1 pts. wt. |
| amylphenyl)-5-chlorobenzotriazol | |
| C₁₂H₂₅OCH₂CH₂O—P(═O)—(OK)₂ | 0.05 pts. wt. |

### EXAMPLE 2

The screw type mixer (φ100) was used as the cool-dissolving apparatus in FIG. 1, in which the space between the cylinder and the passage pipe was separated into two parts. The mixture of high density cellulose triacetate and solvent was supplied in the screw type mixer. In the first temperature setting part, the cooling medium at −55° C. (the temperature thereof was −53° C. at the medium entrance and −49° C. at the medium exit) was fed into the space, and flew therein at 1 m/s of the feeding velocity oppositely to the mixture fed in the cylinder. In the second temperature setting part, the cooling medium at −80° C. (the temperature thereof was −80° C. at the medium entrance and −78° C. at the medium exit) was fed into the space, and flew therein at 1 m/s of the feeding velocity oppositely to the mixture fed in the cylinder. (The cooling medium was Novec FC-77 produced by 3M, boiling point was 97° C., fluid point was −110° C., kinematic viscosity was 6.9×10⁻⁶ m²/s). In the medium passage connecting to the medium circulator, brine at 20° C. was supplied as the medium at 1 m/s. The mixture at 30° C. was fed through the cylinder with the screw rotating for three minutes. The rotation velocity of the screw was 30 rpm. The pressure applied to the obtained dope to be discharged from the cylinder was 1 MPa. Further, the cooled dope was heated with the static mixer to have the temperature at 55° C., and thereafter filtrated with a metal filter whose absolute filtration accuracy was 0.01 mm. Thus, the flow rate of the mixture fed in the cylinder was 1 L/min. The total coefficient of heat transfer was about 150 W/(m²·K). The dope was supplied for the film producing line 40 in FIG. 6, and the film was produced.

The mixture used in Example 2 contained the following materials:

| | |
|---|---|
| cellulose triacetate | 28 pts. wt. |
| (substitution degree, 2.83; viscosity average degree of | |
| polymerization, 320; degree of contained water, 0.4 wt. %; | |
| viscosity in 6 wt. % of methylene chloride solution, | |
| 305 mPa · s). | |
| methyl acetate | 75 pts. wt. |
| cyclopentanone | 10 pts. wt. |
| acetone | 5 pts. wt. |
| methanol | 5 pts. wt. |
| ethanol | 5 pts. wt. |
| plasticizer A (dipentaerythlitolhexaacetate) | 1 pts. wt. |
| plasticizer B (triphenylphosphate) | 1 pts. wt. |
| particles (SiO₂ having particle diameter 20 nm) | 0.1 pts. wt. |
| UV stabilizer a: 2,4-bis-(n-octylthio)-6-(4-hydroxy- | 0.1 pts. wt. |
| 3,5-di-tert-buthylanilino)-1,3,5-triazine) | |
| UV stabilizer b: 2(2′-hydroxy-3′,5′-di-tert- | 0.1 pts. wt. |
| butylphenyl)-5-chlorobenzotriazol | |
| UV stabilizer c: 2(2′-hydroxy-3′,5′-di-tert- | 0.1 pts. wt. |
| amylphenyl)-5-chlorobenzotriazol | |
| C₁₂H₂₅OCH₂CH₂O—P(═O)—(OK)₂ | 0.05 pts. wt. |

In Example 3, a sub dope was prepared in the same method of Example 2 to produce the film by performing the co-casting of the dope in Example 1 and the sub dope simultaneously. The sub dope contained the following materials:

| | |
|---|---|
| cellulose triacetate | 25 pts. wt. |
| (substitution degree, 2.83; viscosity average degree of | |
| polymerization, 320; degree of contained water, 0.4 wt. %; | |
| viscosity in 6 wt. % of methylene chloride solution, | |
| 305 mPa · s). | |
| methyl acetate | 75 pts. wt. |
| cyclopentanone | 10 pts. wt. |
| acetone | 5 pts. wt. |
| methanol | 5 pts. wt. |
| ethanol | 5 pts. wt. |
| plasticizer A (dipentaerythlitolhexaacetate) | 1 pts. wt. |
| plasticizer B (triphenylphosphate) | 1 pts. wt. |
| particles (SILICA having diameter 20 nm) | 0.1 pts. wt. |
| UV stabilizer a: 2,4-bis-(n-octylthio)-6-(4-hydroxy- | 0.1 pts. wt. |
| 3,5-di-tert-buthylanilino)-1,3,5-triazine) | |
| UV stabilizer b: 2(2′-hydroxy-3′,5′-di-tert- | 0.1 pts. wt. |
| butylphenyl)-5-chlorobenzotriazol | |
| UV stabilizer c: 2(2′-hydroxy-3′,5′-di-tert- | 0.1 pts. wt. |
| amylphenyl)-5-chlorobenzotriazol | |
| C₁₂H₂₅OCH₂CH₂O—P(═O)—(OK)₂ | 0.05 pts. wt. |

The same materials were mixed as in Example 2 to obtain the mixture. The cool-dissolving apparatus used in Example 4 was the same as in Example 2, and in each of the spaces between the medium jacket and the cylinder, the cooling medium flew oppositely to the mixture fed in the cylinder. Further, the medium circulator supplied the medium with the medium passage the same as in Example 2.

The mixture at 30° C. was fed through the cylinder with the screw rotating for 6.5 minutes. The rotation speed of the screw was 15 rpm, and the flow rate of the mixture was 400 mL/min. Then the cooled dope obtained from the mixture was heated with the static mixer 38 in FIG. 3 (diameter D1 of the pipe was 67.9 mm, the length L5 was 3 m). The flow rate of the dope supplied for the heat-dissolving apparatus 38 was 400 mL/min, while the linear velocity F of the dope was 0.11 m/min. Note that the total coefficient U of heat transfer was about 50 W/(m²·K). In order to set the predetermined temperature T03′ to 49° C., the heat controller 75 performed a heat transfer calculation from the total coefficient U of heat transfer and the linear velocity F. The temperature T05 of heating medium was set to 55° C., and the flow rate thereof at 10 L/min. Further, hot water was used as the heating medium 74. The dope 50 fed out from the heat-dissolving apparatus 38 did not contain any solid or gel-like materials that could be observed with eyes. Thereafter, the heated dope was filtrated with a metallic filter whose absolute filtration accuracy was 0.01 mm. Then the dope was cast to produce the film in the film producing line 40 in FIG. 6 at the casting temperature T04 of 53° C. In this example, the feed-out temperature T03 of the dope 50 was lower than the casting temperature T04. As a result, it could be prevented to release the air which had been dissolved in the dope, and to generate of air bubble. In the produced film, accordingly, there was no damage caused by generation of air bubble, and the condition of the film was good.

After performing the heating process with the heat-dissolving apparatus 38, the dope 50 was left for 10 days, and there was no gel-like material. Accordingly, the dope was prepared uniformly.

### EXAMPLE 5

In Example 5, the dope in Example 4 and the sub dope in Example 3 were used for producing the film and cast simultaneously.

<Comparison 1>

A screw type mixer (φ100) in which the space between the medium jacket and the cylinder was not separated was used for feeding the mixture through the cylinder. Fluorinert (Trade Mark, produced by 3M) at −70° C. flew in the space oppositely to the mixture in the cylinder. The screw type mixer began to be driven after setting the rotation speed of the screw to 30 rpm. However, the mixture could not be fed for more than an hour from start of the drive of the screw type mixer. Further, even when the mixture was fed, the flow rate of the mixture varied between 0.1 L/min, and 0 L/min-10 L/min for each period of 10 minutes. When the mixture could not be fed, then the mixture contacting to the screw bar was solidified at −70° C., and the elastic modulus was so large, 10⁸ Pa. Accordingly the good dope could not be obtained.

<Comparison 2>

The screw type mixer (φ100) in which the space between the medium jacket and the cylinder was not separated was used for feeding the mixture through the cylinder. Fluorinert at −70° C. flew in the space oppositely to the mixture in the cylinder. Brine at 20° C. was supplied in the medium passage connecting to the medium circulator. The screw type mixer began to be driven with screw rotating at 30 rpm. Although the mixture could be fed, the flow rate thereof was small, 0.2 L/min. Accordingly the good dope could not be obtained.

<Comparison 3>

The screw type mixer (φ30) in which the space between the medium jacket and the cylinder was not separated was used for feeding the mixture through the cylinder. Fluorinert at −75° C. flew in the space oppositely to the mixture fed in the cylinder. In the screw, the medium passage was formed to reach an end thereof, and brine at 20° C. was supplied in the medium passage. The screw type mixer began to be driven with screw rotating at 30 rpm. Although the mixture could be fed stably at the flow rate of 0.1 L/min, the mixture could not be cooled to −70° C., and the polymer did not enough dissolve in the solvent. Accordingly the good dope could not be obtained.

<Comparison 4>

The screw type mixer (φ30) in which the space between the medium jacket and the cylinder was not separated was used for feeding the mixture through the cylinder. Fluorinert at −75° C. flows in the space in the same direction as the mixture in the cylinder. Brine at 20° C. was supplied in the medium passage connecting to the medium circulator. The screw type mixer began to be driven with the screw rotating at 30 rpm. Although the mixture could be fed stably at the flow rate of 0.1 L/min, the feed-out temperature of the dope obtained from the mixture did not become lower to −70° C. Accordingly, the good dope could not be obtained.

<Comparison 5>

The screw type mixer (φ30) in which the space between the medium jacket and the cylinder was not separated was used for feeding the mixture through the cylinder. Fluorinert at −75° C. flew in the space oppositely to the mixture in the cylinder at 0.005 m/s. Brine at 20° C. was supplied in the medium passage. The screw type mixer began to be driven with screw rotating at 30 rpm. Although the mixture could be fed stably at the flow rate of 0.1 L/min, the feed-out temperature of the dope obtained from the mixture did not become lower to −70° C. Thus the dissolution was not enough, and the good dope could not be obtained.

<Comparison 6>

The screw type mixer (φ100) in which the space between the medium jacket and the cylinder was not separated was used for feeding the mixture through the cylinder. Fluorinert at −70° C. flew in the space oppositely to the mixture in the cylinder. Brine at 20° C. was supplied at 0.004 m/s in the medium passage. The screw type mixer began to be driven after setting the rotation speed of the screw to 30 rpm. However, the mixture could not be fed for more than an hour from start of the drive of the screw type mixer. Further, even when the mixture was fed, the flow rate of the mixture varied between 0.1 L/min, and 0 L/min-10 L/min for each period of 10 minutes. The feeding of the dope did not become stable, and the good dope could not be obtained.

<Comparison 7>

The screw type mixer (φ100) in which the space between the medium jacket and the cylinder was not separated was used for feeding the mixture through the cylinder. Fluorinert was fed at −70° C. in the space oppositely to the mixture in the cylinder. Water at 20° C. was supplied at 0.004 m/s in the medium passage. The screw type mixer began to be driven with the screw rotating at 30 rpm of the rotation speed. However, the mixture could not be fed. The temperature of the water became lower, and the water was solidified gradually. Accordingly, the good dope could not be obtained.

<Comparison 8>

After cooled in the same condition of Example 4, the dope obtained from the mixture was heated with a heat-dissolving apparatus 101 illustrated in FIG. 7. The heat-dissolving apparatus includes four static mixers 100. The diameter of the tube in the heat-dissolving apparatus 101 was 67.9 mm, and the length L5 thereof was three meter. Conditions of heating were the same as in Example 4. In a dope 102 discharged from the heat-dissolving apparatus 101, there was no gel-like material. Then, the drive of the heat-dissolving apparatus 101 stopped, and thereafter the heat-dissolving apparatus was left without driving. Many gel-like materials in the dope were generated in a day.

According to the films obtained from the dopes in Examples 1-5, the chemical properties and the physical properties were measured and calculated as follows. The results of the measurement were illustrated in Table 1.

(1) Smoothness Estimation of Film Surface

The film surface of each film was observed with eyes to estimate it. The estimation was made with eyes according to the following four categories:

A: The film surface was smooth;

B: The film surface was smooth, but there were some foreign particles or gel-like materials;

C: The film surface was slightly rough, and there were apparently foreign particles or gel-like materials;

D: The film surface was rough, and there were many foreign particles or gel-like materials.

(2) Estimation of Moisture and Heat Resistance of Film

A sample 1 g of the obtained film was folded and inserted in a glass bottle whose capacity was 15 ml. Then the glass bottle containing the sample was settled under conditions of the temperature at 90° C. and the relative humidity at 100%. Thereafter, the glass bottle was closed for ten days long. Thereafter, the sample was took out from the glass bottle, and the estimation was made with eyes according to the following four categories:

A: There was no extraordinary situation;

B: It smelled slightly, which was caused by decomposition;

C: It smelled so much, which was caused by decomposition;

D: It smelled too much, and the film deforms.

(3) Measurement of Retardation Value (Re value) of Film

Ellipsometer (Polarization analyzer, produced by Shimadzu Corporation) was used in the measurement of the retardation value of the film. The Ellipsometer was positioned in a perpendicular direction to the film surface to radiate the light whose wavelength was 632.8 nm, and to obtain the Re value.

(4) Measurement of Haze of Film

A haze meter (1001 DP type, produced by Nippon Denshoku Industries Co., Ltd.) was used for measurement of haze of the film.

TABLE 1

| | Smoothness of | Resistance of | Re value | Haze |
|---|---|---|---|---|
| | Film Surface | Moist Heat | [mm] | [%] |
| Example 1 | A | A | 1.8 | 0.19 |
| Example 2 | A | A | 1.8 | 0.19 |
| Example 3 | A | A | 1.8 | 0.19 |
| Example 4 | A | A | 1.8 | 0.19 |
| Example 5 | A | A | 1.8 | 0.19 |

The film produced from the dope which is prepared in a method for preparing the polymer solution according to the present invention has no extraordinary properties.

[Method of Producing Polarizing Filter]

In this Experiment, a filter sample of a polarizing filter was produced. In order to make the filter sample, the same two films produced from the dope in each Example were adhered with an adhesive agent of poly vinyl alcohol type to respective surfaces of a polarized element, which had been coated with polyvinyl alcohol, and in which iodine had been absorbed. The filter sample was settled under condition of the temperature at 60° C. and atmosphere of 90% RH for 50 hours.

[Estimation of Polarization Degree]

The parallel transparency Yp and the direct transparency Yc of the polarized light in a visible area were measured with a spectrophotometer. Thereafter, a polarization degree was calculated from the following formula, based on the parallel transparency Yp and the direct transparency Yc:

P=[(Yp−Yc)/(Yp+Yc)]^{1/2}×100(%)

In the polarizing filter in which the films produced from the dope in each Example 1-5, the polarization degree was more than 99.6%. The polarizing filter had the enough endurance. Accordingly, it is preferable to use the obtained film as a protective film of the polarizing filter.

[Producing Antireflection Film]

An antireflection film provided with an antiglare layer was produced in the following process by using the films produced from the dopes in Examples 1-5.

(Preparation of Coating Solution A for Antiglare Layer)

In order to prepare a coating solution A for an antiglare layer, a mixture (DPHA, produced by NIPPON KAYAKU CO., LTD.) was used, in which dipentaerythlitol pentaacrylate and dipentaerythlitol hexaacrylate were mixed. The mixture of 125 g and bis(4-metacrylic thiophenyl) sulfide (MPSMA, produced by SUMITOMO SEIKA CHEMICALS CO., LTD.) of 125 g were dissolved in a mixture solvent of 439 g that contained methylethylketone of 50 wt. % and cyclohexanone of 50 wt. %. Thus a first solution was obtained. Further, second solution was prepared. In the second solution, a photoinitiator for radical polymerization (IRGACURE 907, produced by Chiba Gaigy Japan Limited) of 5.0 g and photosensitizer (KAYACURE DETX, produced by NIPPON KAYAKU CO., LTD.) of 3.0 g were dissolved in methylethyl ketone of 49 g. The second solution was added to the first solution to obtain an added solution. For examination, the added solution was cast and thereafter solidified in ultraviolet ray to obtain a coating layer, which had reflective index of 1.60.

Further, crosslinked polystyrene particles (name of product: SX-200H, produced by Soken Chemical & Engineering Co., Ltd.) of 10 g, whose average particle diameter was 2 μm, were added to the added solution, and this mixture was stirred to disperse the crosslinked polystyrene particles with a high speed stirrer for an hour. The stir speed thereof was 5000 rpm. Thereafter, the filtration of the dispersed solution was made with a polypropylene filter having holes whose pore diameter each was 30 μm. Then the coating solution A for antiglare layer was obtained.

(Preparation of Coating Solution B for Antiglare Layer)

A mixture solvent containing cyclohexane of 104.1 g and methylethyl ketone 61.3 g was stirred by applying air bubble with an air stirrer. Thereby a coating solution for hard coat (DeSolite KZ-7886A, produced by JSR corporation) of 217.0 g that contained zirconium oxide was added to the mixture solvent to obtain an added solution. The added solution was cast and thereafter solidified in ultraviolet ray to obtain a coating, which had reflective index of 1.61. Further, crosslinked polystyrene particles (name of product: SX-200H, produced by Soken Chemical & Engineering Co., Ltd.) of 5 g, whose average particle diameter was 2 μm, were added to the added solution, and this mixture was stirred to disperse the crosslinked polystyrene particles with a high speed stirrer for an hour. The stir speed thereof was 5000 rpm. Thereafter, the filtration of the dispersed solution was made with a polypropylene filter having pores whose diameter each was 30 μm. Then the coating solution B for antiglare layer was obtained.

(Preparation of Coating Solution C for Antiglare Layer)

In order to prepare a coating solution C for an antiglare layer, Methylethyl ketone and cyclohexanone were mixed in ratio of 54 wt. % and 46 wt. % for using as the solvent. Further, a mixture (DPHA, produced by NIPPON KAYAKU CO., LTD.) was used, in which dipentaerythlitol pentaacrylate and dipentaerythlitol hexaacrylate were mixed. The solvent of 52 g was supplied with the mixture of 91 g, a solution for hard coat (DeSolite KZ-7115, produced by JSR corporation) of 199 g that contained zirconium oxide, and a solution for hard coat (DeSolite KZ-7161, produced by JSR corporation) of 19 g that contained zirconium oxide. Thus the mixture was dissolved to obtain a mixed solution. Then in the mixed solution was dissolved a photopolymerizable composition (IRGACURE 907, produced by Chiba Gaigy Japan Limited) of log to obtain an added solution. The added solution was cast and thereafter solidified in ultraviolet ray to obtain a coating, which had reflective index of 1.61.

Further, crosslinked polystyrene particles (name of product: SX-200H, produced by Soken Chemical & Engineering Co., Ltd.) of 20 g, whose average particle diameter was 2 μm, were added to a mixture solvent of 80 g, in which methylethylketone of 54 wt. % and cyclohexanone of 46 wt. % were mixed. This solution was stirred to disperse the crosslinked polystyrene particles with high speed stirrer of 5000 rpm for an hour, and added to the added solution to obtain the dispersed solution. Thereafter, the filtration of the dispersed solution was made with a polyplopyrene filter having pores whose diameter each was 30 μm. Then the coating solution C for antiglare layer was obtained.

(Preparation of Coating Solution D for Hard Coating)

In order to prepare a coating solution D for a hard coating, Methylethylketone of 62 g and cyclohexanone of 88 g were mixed for using as the solvent. Then, ultraviolet curing hard coat composition (DeSolite KZ-7689, 72 wt. %, produced by JSR corporation) of 250 g was dissolved to the solvent. This obtained solution was cast and solidified in ultraviolet ray to form a coating, which had reflective index of 1.53. Further, the solution was filtrated with a polypropyrene filter having pores whose diameter each was 30 μm. Then the coating solution D for hard coating was obtained.

(Preparation of Coating Solution E for Low Reflective Index Layer)

MEK-ST of 8 g (average diameter of particles was 10 nm-20 nm, SiO₂ sol dispersion of methylethylketone, whose solids content degree was 30 wt. %, produced by Niss an Chemical Industries Co., Ltd.) and methylethylketone of 100 g were added to heat closslinked polymer (TN-049, produced by JSR Corporation) of 20093 g containing fluoride that had reflective index of 1.42. This mixture was stirred and filtrated with a polypropylene filter having pores whose diameter was 1 μm. Thus the coating solution for low reflective index layer was obtained.

A cellulose triacetate film having thickness of 80 μm was produced from the dope of Example 1. A surface of the film was coated with the coating solution D by using a bar coater, and thereafter dried at 120° C. Then an ultraviolet light was applied to the coating layer on the film with air-cooled metal halide lamp of 160 W/cm (produced by Eyegraphics Co., Ltd.). The illuminance was thereby 400 mW/cm², and illumination density was 300 mJ/cm². Thus the coating of the dope was solidified to form the hard coat layer of thickness of 2.5 μm on the film. Further, the coating solution A was applied on the hard coat layer on the film with the bar coater. The coating solution A was dried and solidified in the same conditions as in forming the hard coat layer. Thus the antiglare layer of 1.5 μm was formed. Furthermore, the antiglare layer was coated with the coating solution E for the low reflective index layer, and thereafter the coating solution E was dried at 80° C. Then the film was settled to perform the cross-linking at 120° C. for ten minutes and to form a low reflective index layer whose thickness was 0.096 μm.

The coating solution B was used for coating the film instead of the coating solution A. Other conditions were the same to form the antireflection film. Furthermore, the coating solution C was used for coating the film instead of the coating solution A. Other conditions were the same to form the antireflection film.

The cellulose triacetate films were also produced from the dope in Examples 2-5. In order to form the one antiglare layer on the film, the film was coated with one of the three coating solutions A, B, and C in the same condition as in Example 1. Then the coating was made for three coating solutions each. Accordingly, three types of the antireflection film was obtained from the triacetate film produced from one type of the dope.

(Estimation of Antireflection Film)

The following examinations were made for the estimation of the antireflection film.

(1) Specular Reflectance and Integral Reflectance

A spectrophotometer V-550 (produced by JASCO Corporation) was provided with an adapter ARV-474 to measure the specular reflectance at an exiting angle of −5° according to the incident light of wavelength between 380 nm and 780 nm at the incident angle of 5°. Then the average of the specular reflectance of the reflection whose wave length was between 450 nm and 650 nm was calculated to evaluate properties of reflection inhibit. When the specular reflectance was less than 1.5%, then there was no problem in practice.

Further, a spectrophotometer V-550 (produced by JASCO Corporation) was provided with an adapter IRV-471 to measure the specular reflectance according to the incident light of wavelength between 380 nm and 780 nm at the incident angle of 50. Then the average of the specular reflectance of the reflection whose wave length was between 450 nm and 650 nm was calculated to evaluate antireflection properties. When the integral reflectance was less than 1.5%, then there was no problem in practice.

(2) Haze

A haze meter MODEL 1001 DP, (produced by Nippon Denshoku Industries Co., Ltd.) was used for measurement of haze of the antireflection film. When the haze was less than 15%, then there was no problem in practice.

(3) Pencil Hardness

The evaluations of pencil hardness was made as described in JIS K 5400 and the data thereof was used as a criterion of scratch resistance. After the antireflection film was set in atmosphere with the temperature of 25° C. and the humidity of 60%RH for two hours, the surface of the antireflection film was scratched with a 3H test pencil determined in JIS S 6006. Thereby a force of 1 kg was applied to the test pencil. The evaluation of the pencil hardness was “E” (Excellent), when no scratch remains on the surface. The evaluation was “G” (Good), when one or two scratches remained on the surface. The evaluation was “R” (Reject) when more than three scratches remain on the surface.

(4) Contact Angle

After the antireflection film was set in the atmosphere with the temperature of 25° C. and the humidity of 60%RH for two hours, the contact angle to the water on the antireflection film was measured, and the data thereof was used as a criterion of antistaining, especially finger printing stain proofness. When the contact angle was between 90° and 180°, there was no problem in practice.

(5) Color Tint

A CIE standard light source D65 illuminated the antireflection film. When the light from the CIE standard light source D65 incident at 5° to the antireflection film reflected on the surface thereof to be a regular reflection. According to the regular reflection were calculated L* number, a* number and b* number in a CIE 1976 L*a*b* space. The L* number, a* number and b* number represents the color tint of the regular reflection. When the L* number was between 0 and 15, a* number between 0 and 20, and b* number between −30 and 0, then there was no problem in practice.

(6) Coefficient of Dynamic Friction

After the antireflection film was set in the atmosphere with the temperature of 25° C. and the relative humidity of 60% for two hours, the coefficient of dynamic friction was measured with a machine for measuring the coefficient of dynamic friction, HEIDON-14, in which a stainless ball of φ5 mm was used. Thereby, the speed was set to 60 cm/min, and a force of 100 g was aplied on the surface of the antireflection film. When the coefficient of dynamic friction was less than 0.15, then there was no problem in practice.

(7) Antiglare Property

An illumination lamp (8000 cd/M²) without louver emitted a light onto the antireflection film and the light reflects. An image of the illumination lamp formed by the reflection was observed. The estimation of antiglare property was “E” (Excellent) when no outline of the illumination lamp was observed. The estimation was “G” (Good) when the outline was slightly recognized. The estimation was “P” (Pass) when the outline was not clear but recognized. The estimation was “R” (Reject) when the outline was almost clear.

(8) Surface of Antireflection Film

The surface of the antireflection film was observed with eyes. The estimation thereof was “E” (Excellent) when there were no foreign particles or gel-like materials and when the surface was smooth. The estimation was “G” (Good) when there were only some foreign particles or gel-like materials and when the surface is smooth. The estimation was “P” (Pass) when there were foreign particles or gel-like materials such that the surface might be slightly rough. The estimation was “R” (Reject) when there were many foreign particles or gel-like materials such that the surface was rough.

The result of the above examinations were illustrated in Table 2. Note that abbreviations in Table 2 correspond to the above examinations as follows:

SA: Kind of solution for antiglare layer
SR: Specular Reflectance
IR: Integral Reflectance
H: Haze
PH: Pencil Hardness
CA: Contact Angle
DF: Coefficient of Dynamic Friction
AP: Antiglare Property
SF: Surface of Antireflection Film

TABLE 2

| Kind | | | | | | | | | | |
|---|---|---|---|---|---|---|---|---|---|---|
| of | | SR | IR | H | | | Color Tint | | | |
| Dope | SA | (%) | (%) | (%) | PH | CA | L*/a*/b* | DF | AP | SF |
| Ex. 1 | A | 1.1 | 2.0 | 8 | E | 103° | 10/1.9/1.3 | 0.08 | E | E |
| | B | 1.1 | 2.0 | 8 | E | 102° | 9/2.0/−4.0 | 0.09 | E | E |
| | C | 1.1 | 2.0 | 12 | E | 102° | 9/1.7/0.2 | 0.08 | E | E |
| Ex. 2 | A | 1.1 | 2.0 | 8 | E | 103° | 10/1.9/1.3 | 0.08 | E | E |
| | B | 1.1 | 2.0 | 8 | E | 102° | 9/2.0/−4.0 | 0.09 | E | E |
| | C | 1.1 | 2.0 | 12 | E | 102° | 9/1.7/0.2 | 0.08 | E | E |
| Ex. 3 | A | 1.1 | 2.0 | 8 | E | 103° | 10/1.9/1.3 | 0.08 | E | E |
| | B | 1.1 | 2.0 | 8 | E | 102° | 9/2.0/−4.0 | 0.09 | E | E |
| | C | 1.1 | 2.0 | 12 | E | 102° | 9/1.7/0.2 | 0.08 | E | E |
| Ex. 4 | A | 1.1 | 2.0 | 8 | E | 103° | 10/1.9/1.3 | 0.08 | E | E |
| | B | 1.1 | 2.0 | 8 | E | 102° | 9/2.0/−4.0 | 0.09 | E | E |
| | C | 1.1 | 2.0 | 12 | E | 102° | 9/1.7/0.2 | 0.08 | E | E |
| Ex. 5 | A | 1.1 | 2.0 | 8 | E | 103° | 10/1.9/1.3 | 0.08 | E | E |
| | B | 1.1 | 2.0 | 8 | E | 102° | 9/2.0/−4.0 | 0.09 | E | E |
| | C | 1.1 | 2.0 | 12 | E | 102° | 9/1.7/0.2 | 0.08 | E | E |

Table 2 teaches that the cellulose triacetate film produced from the dopes in Examples 1-5 was used for the antireflection film in which the antiglare property and the antireflection property were excellent, the color tint was low, and the evaluations of pencil hardness, the contact angle or the finger printing stain proofness, and the coefficient of dynamic friction were excellent.

Then each of the antireflection films produced from the dopes in Examples 1-5 was used for the polarizing filter which was used in the liquid crystal display, such that the antireflection film might construct a front surface of the liquid crystal display. In the liquid crystal display, the external light was not mixed with a light for displaying images on the liquid crystal display. Further, the outline of reflected images of the fluorescent lamp were not remarkable, and the displayed images were clearly perceived. The fingerprint was hardly formed on the liquid crystal display.

Examples 6 and 7 were further made. In Examples 6 and 7, the temperature in the cylinder 11 was measured at each of several positions between the supply opening 16 and the outlet opening in the cylinder end 17. The same mixture was used as in Example 1. Note that the explanation of the same conditions was omitted as in Example 1.

### EXAMPLE 6

The mixture was supplied in the cool-dissolving apparatus 10 for dissolving in FIG. 1 (diameter of the cylinder was 30 mm). In the first temperature setting part 20, Fluorinert of −75° C. flew at 5 m/s in the space oppositely to the mixture fed in the cylinder 11. In the second temperature setting part 21, the brine of 20° C. flew in the space. The temperature of the mixture in the cylinder was measured at the following several positions which were represented as ratio of distance from the supply opening to the length L4.

(Position, Temperature (° C.) of mixture)=(0,3), (0.1,−45), (0.3,−60), (0.55,−67), (0.75,−68.5), (1,−71)

The volume efficiency was 98%, and the polymer was dissolved smoothly, and the mixture was fed smoothly.

### EXAMPLE 7

The mixture was supplied in the cool-dissolving apparatus 10 for dissolving in FIG. 1 (diameter of the cylinder was 30 mm). In the first temperature setting part 20, Fluorinert of −75° C. flew at 10 m/s in the space oppositely to the mixture fed in the cylinder 11. The temperature of the mixture in the cylinder was measured at the same positions as in Example 6. (Position, Temperature (° C.) of mixture)=(0,−18), (0.1,−61), (0.3,−69), (0.55,−70), (0.75,−71), (1,−72)

The feeding of the mixture was extremely unstable, and it took two hours until discharging the dope from the outlet opening in the cylinder end. The flow rate of the mixture did not become stable even after start of discharging the dope. However, the dope had the quality enough to use in the film producing line.

Various changes and modifications are possible in the present invention and may be understood to be within the present invention.

What is claimed is:

1. A cool-dissolving apparatus for cooling a mixture of polymer and a solvent, in order to produce a polymer solution from said mixture, comprising:
a mixture feed section in which said mixture is fed and said polymer is dissolved to said solvent such that said polymer solution may be obtained;
an opening formed in an upstream side of said mixture feed section, said mixture being supplied through said opening in said mixture feeding section;
an end portion provided at a downstream end of said mixture feed section, said polymer solution being discharged through said end portion from said cool-dissolving apparatus, and
a cooling section for adjusting a temperature T01 of said mixture in said opening and a temperature T02 of said polymer solution in said end portion, so as to satisfy a formula T01>T02.

2. A cool-dissolving apparatus as described in claim 1, wherein said mixture feeding section is a pipe in which a position is represented as a relative value Rv of said position to a length between an upstream edge of said opening and an downstream end of said end portion, and a temperature T of said mixture or said polymer solution is adjusted at said relative value Rv so as to satisfy following formulae:
T(° C.)≧−400×Rv−20(0≦Rv≦0.1)
T(° C.)≧(−1/9)×(200×Rv+520)(0.1<Rv≦1.0).

3. A cool-dissolving apparatus as described in claim 2, wherein said cooing section includes N temperature setting parts (N≧2), said pipe being cooled for regulating a temperature of said polymer solution to a predetermined temperature in each of said temperature setting part.

4. A cool-dissolving apparatus as described in claim 3, further comprising a screw in said pipe, said mixture or said polymer solution is fed from said opening to said end portion by rotation of said screw.

5. A cooing apparatus as described in claim 4, wherein said pipe is cylinder-shaped and has a double structure constructed of an inner wall and an outer wall which are disposed concentrically in section such that a space is formed between said inner wall and said outer wall, said space is partitioned at a border at neighboring temperature setting parts so as to form N chambers, and a cooling medium having a different temperature in accordance with said temperature setting parts flows in said each chamber.

6. A cool-dissolving apparatus as described in claim 5, wherein said cooling medium flows oppositely to a feeding direction of said mixture or said polymer solution in said each chamber.

7. A cool-dissolving apparatus as described in claim 5, wherein said N temperature setting parts are provided along said pipe, said temperature setting part closest to said opening is a first temperature setting part, said temperature setting part closest to said end portion is a N^{th} temperature setting part, and a temperature of said cooling medium is set higher in said first temperature setting part than in said N^{th} temperature setting part.

8. A cool-dissolving apparatus as described in claim 7, wherein a number N of said temperature setting parts is two.

9. A cool-dissolving apparatus as described in claim 8, wherein the temperature of said cooling medium in said first temperature setting part is between −60° C. and 0° C., and that in said second temperature setting part is between −100° C. and −45° C.

10. A cool-dissolving apparatus as described in claim 7, wherein a difference of the temperature of said cooling medium among said N temperature setting parts is between 1° C. and 100° C.

11. A cool-dissolving apparatus as described in claim 7, wherein said cooling medium has a melting point at less than 0° C., a boiling point at more than 30° C., and a kinetic viscosity at less than 2×10⁻⁴ m²/s.

12. A cool-dissolving apparatus as described in claim 7, wherein said outer wall of said pipe has a medium entrance and a medium exit in each temperature setting part, and there is a difference of temperature by 50° C. in said cooling medium at said medium entrance and said medium exit.

13. A cool-dissolving apparatus as described in claim 7, wherein a flowing velocity u1 of said cooling medium flowing in said chamber is in a region determined in the following formula:
0.01(m/s)≦u1≦10(m/s).

14. A cool-dissolving apparatus as described in claim 7, wherein said cooling medium flows oppositely to said mixture of said polymer solution that are fed in said inner wall.

15. A cool-dissolving apparatus as described in claim 7, wherein, while L1 is a total length of said space, a length L0N of said space in said N^{th} temperature setting parties satisfies a following formula: (0.1×L1/N)<L0N<(2×L1/N).

16. A cool-dissolving apparatus as described in claim 7, wherein a total coefficient of heat transfer between said mixture or said polymer solution and said cooling medium is between 1 W/(m²·K) and 1000 W/(m²·K).

17. A cool-dissolving apparatus as described in claim 5, wherein a medium passage is provided in said screw, and a temperature control medium flows through said medium passage to control a temperature of said screw.

18. A cool-dissolving apparatus as described in claim 17, wherein said temperature control medium has a melting point at less than 0° C., a boiling point at more than 30° C., and a kinetic viscosity at less than 2×10⁻⁴ m²/S.

19. A cool-dissolving apparatus as described in claim 17, wherein a flow rate u2 of said temperature control medium flowing in said medium passage satisfies a formula:
0.1(L/min)≦u2≦100(L/min).

20. A cool-dissolving apparatus as described in claim 17, wherein said screw has a pitch L3, said opening through which said mixture is supplied in said pipe has a diameter D, and said medium passage extends from a central line of said opening into a feed direction of said mixture at a length L2 which satisfies a formula:
(D/2)≦L2≦(L3/2).

21. A cool-dissolving apparatus as described in claim 20, wherein said mixture has a temperature T1 at said opening, and part of said screw has a temperature T2 in said first temperature setting part such that a difference (T2−T1) satisfies a formula:
−100° C.≦(T2−T1)≦0° C.

22. A cool-dissolving apparatus as described in claim 20, wherein said mixture in said opening has viscosity of less than 10⁴ Pa·s, and elastic modulus of more than 10⁶ Pa.

23. A cool-dissolving apparatus as described in claim 20, wherein, when P1 and P2 are determined as respective pressures of said mixture at said opening and said polymer solution at said end portion of said pipe, a difference |P2−P1| is less than 10 Mpa.

24. A cool-dissolving apparatus as described in claim 4, wherein a rotation speed of said screw is between 1 rpm and 200 rpm.

25. A cool-dissolving apparatus as described in claim 1, wherein said cool-dissolving apparatus is used in combination with a heat-dissolving apparatus in which said polymer solution discharged from said cool-dissolving apparatus is heated.

26. A heat-dissolving apparatus for heating a polymer solution which is obtained by cooling a mixture of a polymer and a solvent with a cool-dissolving apparatus, said heat-dissolving apparatus comprising:
a pipe in which said polymer solution flows, said pipe being provided to always extend horizontally or upwardly in a downstream side; and
a heat controller for controlling a temperature of said polymer solution in said pipe so as to be higher at exiting from said heat-dissolving apparatus than at entering in said heat-dissolving apparatus.

27. A heat-dissolving apparatus as described in claim 26, further comprising a jacket surrounding said pipe, a heating medium flowing through a passage formed between said pipe and said jacket, so as to heat said polymer solution in said pipe.

28. A heat-dissolving apparatus as described in claim 27, wherein said heating medium flows in said passage oppositely to a feeding direction of said polymer solution.

29. A heat-dissolving apparatus as described in claim 27, wherein a solid of said polymer that remains in said polymer discharged from said cool-dissolving apparatus is dissolved.

30. A heat-dissolving apparatus as described in claim 26, wherein a viscosity of said polymer solution fed in said pipe decreases more than 10 Pa·s.

31. A heat-dissolving apparatus as described in claim 27, wherein said heat controller performs a heat transfer calculation based on total coefficient U of heat transfer in said heat-dissolving apparatus and linear velocity F of said polymer solution and adjusts said temperature of said heating medium based on a result of the heat transfer calculation so as to control a feed-out temperature t1 of said polymer solution at exiting from said heat-dissolving apparatus to a predetermined temperature t1′.

32. A heat-dissolving apparatus as described in claim 31, wherein said heat controller adjusts said linear velocity of said polymer solution and a pressure in said pipe based on the result of the heat transfer calculation so as to control said temperature of said heating medium.

33. A heat-dissolving apparatus as described in claim 31, wherein said total coefficient of heat transfer between said mixture or said polymer solution and said heating medium is between 10 W/(m²·K) and 1000 W/(m²·K).

34. A heat-dissolving apparatus as described in claim 31, wherein said polymer solution fed out from said heat-dissolving apparatus is supplied in a film producing apparatus, said feed-out temperature t1 of said polymer solution is lower than a cast temperature t2 of said polymer solution cast onto a substrate on a die of said film producing apparatus.

35. A heat-dissolving apparatus as described in claim 34, wherein said solvent evaporates from said polymer solution cast on said substrate in said film producing apparatus such that said polymer in said polymer solution forms a film.

36. A heat-dissolving apparatus as described in claim 34, wherein said polymer is cellulose acylate.

37. A heat-dissolving apparatus as described in claim 36, wherein at least one solution is cast with said polymer solution simultaneously.

38. A heat-dissolving apparatus as described in claim 35, wherein said film is used as a protective film for a polymerizing filter.

39. A heat-dissolving apparatus as described in claim 38, wherein said polarizing filter is used in a liquid crystal display.

40. A heat-dissolving apparatus as described in claim 37, wherein said film is used as a protective film for a polymerizing filter.

41. A heat-dissolving apparatus as described in claim 40, wherein said polarizing filter is used in a liquid crystal display.
